(19) United States
(12) Patent Application Publication
(10) Pub. No.: US 2009/0312168 A1
(43) Pub. Date: Dec. 17, 2009

(54) Elastic Roll Cover, Covered Roll and Method of Manufacturing a Covered Roll

(75) Inventors: Juha Ruotsi, Oulu (FI); Jan Paasonen, Kerava (FI); Jari Sirkko, Oulu (FI)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 12/306,868

(22) PCT Filed: Jun. 29, 2007
(86) PCT No.: PCT/EP07/56589

§ 371 Date: Dec. 29, 2008

(30) Foreign Application Priority Data
Jun. 30, 2006 (FI) 20060636

(51) Int. Cl. F16C 13/00; C08L 21/00; B32B 27/04

(52) U.S. Cl. 492/56; 525/55; 428/295.1

(57) ABSTRACT

An elastic roll cover for manufacturing or finishing of a fiber web material has at least one layer of rubber mixture, wherein the at least one layer of rubber mixture contains synthetic fiber polymer in powder form.

### CROSS REFERENCES TO RELATED APPLICATIONS

This application is a U.S. national stage application of International App. No. PCT/EP2007/056589, filed Jun. 29, 2007, the disclosure of which is incorporated by reference herein, and claims priority on Finnish App. No. 20060636, filed Jun. 30, 2006.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to an elastic roll cover and rolls for manufacturing or finishing of web material, like paper or board.

In manufacturing or finishing of a fiber web material rolls are used in several positions which comprise a roll body covered with a polymer composition. For some positions elasticity of the roll surface is preferred, then the rolls are covered with rubber mixtures. Typical elastomers used in these rubber mixtures are nitrilebutadienerubber (NBR), hydrated nitrilebutadienerubber (HNBR), chlorosulphonated polyethylenerubber (CSM), natural rubber, styrenebutadienerubber (SBR), ethylenepropylenedienerubber (EPDM) and chloroprenerubber (CR).

Rubber mixture covers are used for example with press rolls in the press section, suction rolls in wire and press section and sizer and film transfer rolls in surface treatment or coating of the web. In these positions the roll surface is in abrading contact with the web or a fabric supporting the web and in addition to that it is often under a load, for example in a nip contact with a counter roll. The environment is thus very wearing. Simultaneously, the roll surface must remain faultless to ensure good quality of the web and good runability of the machine. Generally, the cover is made thick enough to enable reconditioning of the worn surface by grinding.

Different filler materials are used in rubber formulations to achieve desired properties. The most commonly used fillers are carbon black, silicates (as clays) and silicon oxides. Fillers used less commonly and for special purposes are, for example, titan dioxide and thermoplastic powders. The amount of filler could be for example 30-100 parts-of-weight of filler to 100 parts-of-weight of elastomer (phr). Fillers are used inter alia to adjust ductility, strength, elasticity, wear resistance, hardness, thermal resistance and release properties of the cover. A problem with fillers is that while improving one property it often simultaneously decreases some other property. As a result, compromises are to be done.

Important properties of roll covers made of rubber mixtures are nowadays long operating life, good wear resistance and low thermal generation under dynamic load. Especially, long operating life improves productivity of the web manufacturing or web finishing machine. Operating life depends on several factors. Specifically wear resistance, tear strength and resistance to crack development are such factors. Wear resistance and operating life are improved inter alia by using HNBR elastomers, or polymers modified by zinc methacrylates or by adding specific fillers, like polypropylene or polyethylene powders (PP, PE) or fiber fillers. All these have however their drawbacks, like high price (e.g., HNBR elastomers), low chemical resistance (e.g., zinc methacrylate modified polymers), elastic non-resiliency, low thermal resistance (PE and PP powders) and high anisotropy (fiber fillers).

Aromatic polyamides (aramides) are also used as fillers in fiber-form (length typically 3-6 mm) in low amounts (e.g., 3-6 phr) with purpose to increase resiliency, ductility, tear resistance and abrasion resistance.

In a published patent U.S. Pat. No. 6,328,681 a roll cover is disclosed having as a filler 25-75 phr of ultra high molecular weight (typically 2-10×10e6) polyethylene (UHMWPE). In a published patent U.S. Pat. No. 6,918,865 a roll cover is disclosed, in which amount of UHMWPE is 10-24 phr. This filler improves especially wear resistance. It has weaknesses when used in such high amounts, such as low thermal resistance, proneness to heat generation and non-resiliency.

### SUMMARY OF THE INVENTION

The present invention has been made in view of the above discussed aspects and provides an elastic roll cover for manufacturing or finishing of a fiber web material, comprising at least one layer of rubber mixture, wherein the at least one layer of rubber mixture contains synthetic fiber polymer in powder form.

The fiber polymer is preferably selected from the group comprising polyamide-based polymers and polyether-based polymers, e.g polyamide, especially aromatic polyamide, preferably aramid produced of terephtalic acid and p-phenylenediamine; polyetheretherketone, polyethersulphone or polyetherimide.

The amount of the polymer powder is preferably ≧5 to ≦40, more preferably ≧10 to ≦30 parts of weight to 100 parts of weight of elastomer of the rubber mixture.

The polymer powder preferably has a glass transition temperature of ≧160° C.

The largest dimension of the polymer powder particles preferably lies in the range of ≧5 to ≦300 μm, more preferably in the range of ≧50 to ≦150 μm.

The density of the polymer powder is preferably ≧1.4 to ≦1.5 g/cm³.

Preferably, an elastomer matrix of the rubber mixture contains, and is preferably made of, an olefin-based rubber like e.g. nitrile butadiene rubber, styrene butadiene rubber, chlorosulphonated polyethylene rubber, ethylenepropylene rubber, hydrated nitrile butadiene rubber and chloroprene or natural rubber.

In a preferred embodiment, fillers and additives are included in the rubber mixture.

The present invention further provides a covered roll for manufacturing or finishing of a fiber web material, having a roll body and the elastic roll cover described herein (which covers the roll core).

It is preferred that the covered roll according to the present invention is a press roll, a suction roll, a sizer roll or a coater roll.

Another aspect of the present invention is a method for manufacturing a roll for manufacturing or finishing of a fiber web, by covering a roll body with an elastic cover comprising at least one layer of rubber mixture, in which method at least one layer of vulcanizable rubber mixture is applied to the surface of the roll body and the rubber mixture is vulcanized, characterized in that synthetic fiber polymer in form of a powder is incorporated in the rubber mixture.

In the method, the roll body may be treated to improve adhesion prior to applying of the rubber mixture on the surface of the roll body.

A further aspect of the present invention resides in a use of a rubber mixture containing synthetic fiber polymer in powder form for a roll cover for manufacturing or finishing of a fiber web.

### BRIEF DESCRIPTION OF THE DRAWINGS

Not applicable.

### DESCRIPTION OF THE PREFERRED EMBODIMENTS

According to the present invention, an elastic roll cover comprises at least one layer of rubber mixture, preferably as a top (outermost) layer, containing synthetic fiber polymer powder as a filler. This elastic roll cover simultaneously shows improved tear strength, ductility and hardness as well as crack resistance, chemical resistance and thermal resistance.

The covered roll according to the present invention has a roll body which generally comprises a metal such as cast iron or steel and is covered with the elastic roll cover according to the invention.

Preferably, the filler is a so called high-performance developed polymer, i.e. one with good thermal resistance (preferably resistant to temperatures of at least 100° C.). Examples of such polymers are: polyetheretherketone (PEEK), polyethersulphone (PES), polyimide (PI), polyamide-6.6 and polyethyleneterephthalate (PETP), which polymers must also be suitable for fiber manufacturing methods. The polymers are usually first cast as a fiber and are then processed into powders before they are used in the present invention.

It is preferred that the fiber polymer (filler) is a polyamide-based or polyether-based polymer, in order to achieve a further improved tear strength, ductility and hardness.

Specifically, the polymer may be polyamide (PA), especially aromatic polyamide (aramide), preferably aramide produced of terephtalic acid and p-phenylene diamine (PPD-T-aramide), polyetheretherketone (PEEK), polyethersulfone (PES) or polyetherimide (PEI). Besides an improvement of the above listed physical properties, the use of these specific polymers in powder form as a filler leads to a homogeneous distribution in the latter described elastomer matrix, so that the cover properties are advantageously isotropic.

The powder is preferably used in amounts of ≧5 to ≦40, more preferably ≧10 to ≦30 parts-of-weight per 100 parts-of-weight of elastomer (phr). Below 5 parts-of-weight, its effect of improving the wear resistance as well as the ductility and the hardness may be insufficient, while above 40 parts-of-weight, the ductility may be adversely affected and the cover tends to be more easily deteriorated by heat and chemical influences. Thus, for achieving a good balance of these properties, the above-mentioned range of the powder content is preferred, with a superior balance being achieved in the more preferred range.

Useful elastomers to be used in the invention as a matrix, in which the synthetic fiber polymer is embedded, are olefin-based rubbers and natural rubber. By using such a rubber as the matrix, favorable elasticity combined with crack resistance, chemical resistance and thermal resistance, respectively, are obtained.

As a specific example, nitrilebutadiene rubber (NBR) has turned out to be very useful in terms of the compatibility with the fiber polymer, and the physical properties of the cover can be easily controlled by the use of NBR polymer. Similar advantageous results are achieved by the use of styrenebutadiene rubber (SBR), chlorosulphonated polyethylene rubber (CSM), ethylenepropylenediene rubber (EPDM), hydrated nitrilebutadiene rubber (HNBR), chloroprene rubber (CR) and natural rubber (NR). Especially useful are NBR, SBR, CSM and EPDM.

The biggest dimension of the polymer powder particles is preferably ≧5 to ≦300 μm, more preferably ≧50 to ≦150 μm. These dimensions allow a very homogenous distribution of the powder particles in the elastomer and further improve the tear strength, the ductility and the hardness of the roll cover. Within the more preferred range, these effects are even better.

The density of the powder is typically ≧1.4 to ≦1.5 g/cm³, which allows a desired setting of the physical and chemical properties of the roll cover.

The glass transition temperature of the powder is most preferably equal to or more than 160° C., because in its actual application on a roll, the roll cover is often exposed to elevated temperatures, e.g. in a nip contact with a counter roll. With the preferred glass transition temperature, degradation of the roll cover performance due to heat can be largely suppressed.

Typically the powder is quite polymorphic, i.e. it has ability to exist in more than one crystal structure. Particles may be elongate, roundish or flake-like. Especially the biggest particles are elongate (diameter typically 10-50 μm). The elongate form allows a suitable reinforcement of the elastomer and further enhances the tear resistance and the crack resistance, respectively.

The invention is applicable to be used in all rolls in manufacturing or finishing fiber web material, like paper or board, in which rubber or rubber mixture covers are used. The roll may be for example a press roll, a suction roll, a sizer roll or a coater roll.

Chemical compatibility of the powder with the elastomer matrix can be improved if needed by surface activation of the powder or by adding adhesion improving ingredients to the rubber mixture.

In addition to the fiber powder additional inorganic and organic fillers and additives can preferably be used, such as carbon black, silicon dioxide, clay or other polymer powders, like thermoplastic polyolefins (e.g., polypropylene, polyethylene, HMWPE and UHMWPE). The amount of additional fillers is preferably 50-100 phr, more preferably 60-80 phr. The amount of the optional thermoplastic polyolefin is preferably less than 10 phr.

The powder can be compounded to the rubber mixture by conventional means like with roll mixer or chambered mixer.

The roll cover comprises generally of 1-4 layers of rubber mixture, i.e. 1, 2, 3 or 4 layers. Thickness of the layers is typically 10-50 mm, more preferably 15-30 mm and most preferably 20-25 mm for the top layer and 2-10 mm for the lower layers.

In order to combine an improved wear resistance with a suitable ductility and hardness in e.g. a paper manufacturing process, the roll cover has a Pusey & Jones (P&J) hardness of preferably 5 to 50, more preferably 10 to 30 and still more preferably 12 to 25.

Especially in a finishing process like e.g. sizing of paper, a superior uniformity of the finished surface, e.g. a very uniform surface sizing, is achievable when the outermost layer of the roll cover, preferably the at least one layer of rubber described above, exhibits a surface roughness Ra of preferably 1.2 μm or more, more preferably 1.4 μm or more. Useful ranges for the value of Ra for obtaining the uniform surface finishing are e.g. 1.4 to 1.7 μm, more preferably 1.4 to 1.6 μm and still more preferred 1.5 to 1.6 μm.

In a typical cover manufacturing process the surface of the roll body is pretreated to improve adhesion (by abrasive blasting etc.) and 1-4 layers of adhesive are applied on it (thickness of one layer about 10-15 μm). After that desired amount of rubber mixture layers are produced and set (vulcanized). The vulcanizing can be achieved by e.g. the use of sulfur, one or more sulfur-containing compounds, zinc white or peroxide. For vulcanizing the roll is wrapped by a film and vulcanizing is performed by heating in an oven. Finally the cover is machined to desired dimensions. It is common to produce the cover by spirally extruding rubber mixture on the roll body. Most of all, the fiber powder filler gives long operation life and good wear resistance, especially good wear resistance in abrasion. Moreover, tear strength, ductility and hardness, crack resistance, chemical resistance and thermal resistance are improved.

The cover is of isotropic nature, therefore drawbacks due to anisotropy are avoided. Manufacturing is easy, because viscosity increase is not inappropriate. Roll cover performance in the paper machine is reliable.

### EXAMPLES

### Example 1

Roll body of metal was covered by a formulation having in weight-parts:

| | |
|---|---|
| NBR elastomer | 100 |
| Carbon black | 50 |
| Methacrylate monomer | 10-35 |
| Filler (inorganic silica-based) | 5-15 |
| Aramide powder Twaron 5011 | 25 |
| Antioxidant/antiozonate | 3 |
| Peroxide (50%) | 8 |
| UHMWPE | 9 |

### Example 2

A roll was covered with a formulation having in weight-parts:

| | |
|---|---|
| NBR elastomer | 100 |
| Fillers (inorganic: carbon black, silica, | 70-80 |
| and polymer (PE) -based mixture) | |
| Methacrylate monomer | 10-35 |
| Aramide powder Twaron 5011 | 25 |
| Antioxidant/antiozonate | 3 |
| Peroxide (50%) | 8 |

Test results

Properties of the covers above were studied and compared to a conventional NBR-cover in which the only difference was that only conventional carbon black/silica/silicate fillers were used, but no aramide powder at all. Results are given in the table below.

| | | | | | Comparative NBR | |
|---|---|---|---|---|---|---|
| | | | | | (conventional carbon | |
| | | | | | black/silica/silicate | |
| | Example 1 | | Example 2 | | fillers) | |
| Hardness | 15 | P&J | 18 | P&J | 15 | P&J |
| Abrasion resistance (DIN | 150 | mm³ | 130 | mm³ | 300 | mm³ |
| 53516), volumetric loss | | | | | | |
| Break resistance | 17 | MPa | 18 | MPa | 17 | MPa |
| Elongation at break | 57% | | 89% | | 45% | |
| Tear strength | 30 | kN/m | 40 | kN/m | 30 | kN/m |

| | | | |
|---|---|---|---|
| (ASTM D624, die C) | | | |
| Tan delta | 0.13 | 0.16 | 0.16 |
| (30° C.) | | | |
| Tan delta | 0.08 | 0.13 | 0.09 |
| (90° C.) | | | |
| Residual compression | 15% | 25% | 10% |
| (70° C./22 h) | | | |

The hardness was measured according to ASTM D531, break resistance and elongation at break were both measured according to ASTM D412, tanδ (30° C., 90° C.) was measured with a DMTA (single cantilever mode) and the residual compression was measured according to ASTM D395.

It is clear from the table that superior wear resistance as well as equal or better other mechanical properties are achieved with compositions of the invention compared to prior art compositions of equal hardness level.

1-13. (canceled)

14. An elastic roll cover for manufacturing or finishing of a fiber web, comprising: at least one layer of an isotropic rubber mixture, which isotropic rubber mixture incorporates synthetic fiber polymer selected from the group consisting of: polyamide-based polymers and polyether-based polymers, which synthetic fiber polymer is in powder form, the isotropic rubber mixture forming the elastic roll cover.

15. The elastic roll cover of claim 14 wherein the largest dimension of a particle of the synthetic fiber polymer in powder form forming the elastic roll cover is ≧5 to ≦300 μm.

16. The elastic roll cover of claim 14 wherein the isotropic rubber mixture includes an elastomeric matrix, and wherein an amount of the synthetic fiber polymer in powder form is 5 to 40 parts of weight to 100 parts of weight of elastomer matrix of the isotropic rubber mixture.

17. The elastic roll cover of claim 14 wherein the glass transition temperature of the synthetic fiber polymer in powder form is ≧160° C.

18. The elastic roll cover of claim 14 wherein the largest dimension of a particle of the synthetic fiber polymer in powder form forming the elastic roll cover is ≧50 to ≦150 μm.

19. The elastic roll cover of claim 14 wherein the density of the synthetic fiber polymer in powder form is ≧1.4 to ≦1.5 g/cm³.

20. The elastic roll cover of claim 14 wherein the isotropic rubber mixture includes an elastomeric matrix containing an olefin-based rubber or natural rubber.

21. The elastic roll cover of claim 14, wherein fillers and additives are included in the isotropic rubber mixture.

22. A covered roll for manufacturing or finishing of a fiber web, comprising
a roll body; and
an elastic roll cover having at least one layer of an isotropic mixture of rubber which incorporates synthetic fiber polymer selected from the group consisting of:
polyimide-based polymers and polyether-based polymers, which synthetic fiber polymer is in powder form, the isotropic mixture forming the elastic roll cover.

23. The covered roll of claim 22, wherein the roll body is selected from the group consisting of: a press roll, a suction roll, a sizer roll and a coater roll.

24. The covered roll of claim 22 wherein the isotropic rubber mixture includes an elastomer matrix, and wherein an amount of the synthetic fiber polymer in powder form is ≧5 to ≦40 parts of weight to 100 parts of weight of elastomer matrix of the isotropic rubber mixture.

25. A method for manufacturing a covered roll for manufacturing or finishing a fiber web, comprising the steps of:
covering a roll body having a roll surface with at least one layer of a vulcanizable isotropic rubber mixture which incorporates synthetic fiber polymer selected from the group consisting of: polyamide-based polymers and polyether-based polymers, which synthetic fiber polymer is in powder form, by applying the vulcanizable rubber mixture to the roll surface of the roll body; and
vulcanizing the isotropic rubber mixture on said roll surface to form the covered roll.

26. The method of claim 25 wherein prior to applying vulcanizable isotropic rubber mixture to the roll surface, the roll surface of the roll body is treated to improve adhesion of the vulcanizable rubber mixture.

27. The method of claim 25 further comprising the step of manufacturing or finishing of a fiber web using the covered roll.
